(19) United States
(12) Patent Application Publication
(10) Pub. No.: US 2016/0028781 A1
(43) Pub. Date: Jan. 28, 2016

(54) SURFACE COMPUTING BASED SOCIAL INTERACTION

(71) Applicant: International Business Machines Corporation, Armonk, NY (US)

(72) Inventors: Denise A. Bell, Austin, TX (US); Jana H. Jenkins, Raleigh, NC (US); Jeffrey A. Kusnitz, Campbell, CA (US); Sarah Plantenberg, San Francisco, CA (US)

(21) Appl. No.: 14/338,334

(22) Filed: Jul. 22, 2014

(51) Int. Cl. H04L 29/06; G06F 3/0484; H04L 29/08

(52) U.S. Cl. CPC H04L 65/403; H04L 67/02; G06F 3/04842

(57) ABSTRACT

A method for surface computing based social interaction is provided. The method includes projecting by a surface computing system disposed in a public space, a multiplicity of different surface computing displays upon respectively different flat surfaces in the public space, each of the different surface computing displays including a single application user interface to a collaborative application executing in the surface computing system. The method also includes concurrently accepting user input through the single application user interface of different ones of the different surface computing displays. The method further includes providing accepted user input from each of the different surface computing displays to the collaborative computing application. Finally, the method includes presenting through all of the different surface computing displays the accepted user input to the collaborative computing application.

### BACKGROUND OF THE INVENTION

1. Field of the Invention

The present invention relates to surface computing and more particularly to the use of surface computing in social interactions.

2. Description of the Related Art

Surface computing refers to the use of an ordinary flat surface as the primary mode of interaction with a computing device and the acceptance of common objects to direct user inputs in the computing device. Generally, a combination of one or more digital projectors and an array of cameras permit both the projected display of the graphical user interface of a surface computing system onto a flat surface, and also the detection of user input on the flat surface. Practical applications of surface computing include hotel lobby kiosks, restaurants, airline check-in terminals, hospital nursing stations and group conference room tables.

Because of the ease in which surface computing can be deployed in a public space such as a restaurant or hotel, without the requirement of a dedicated display device, new uses for computing in the social context of a public space are possible. In this regard, many problems inherent to a public space are addressable through a passive group view to a single computing display. To wit, the airline industry has embraced the use of a common publicly viewable display to present real-time information regarding aircraft departure, boarding times and upgrade and standby status. Likewise, some restaurants use a public display to indicate a number of available tables and a wait time for other tables. In all cases, however, the view is passive and individuals present in the public space are not permitted to interact with the display beyond viewing.

### BRIEF SUMMARY OF THE INVENTION

Embodiments of the present invention address deficiencies of the art in respect to social interaction in a public space and provide a novel and non-obvious method, system and surface computing program product for surface computing based social interaction. In an embodiment of the invention, a surface computing data processing system is configured for surface computing based social interaction. The system includes a surface computing system that is disposed in a public space and includes a host computing system of at least one computer with memory and at least one processor and an operating system executing thereon and hosting operation of a collaborative computing application generating a single application user interface. The system also includes a multiplicity of different surface computing displays each projected upon a different flat surface in the public space, and each projecting the single application user interface.

Of note, each of the different surface computing displays concurrently accepts user input through the single application user interface. Furthermore, each of the different surface computing displays provides accepted user input to the collaborative computing application. As such, the collaborative computing application includes program code executing in the memory of the surface computing system that is enabled to present through all surface computing displays the accepted user input to the collaborative computing application.

In one aspect of the embodiment, the user input is a question pertaining to the public space. In another aspect of the embodiment, the user input is a response provided as user input in one of the multiplicity of different surface computing displays to a question provided as user input in another of the multiplicity of the different surface computing displays. In yet another aspect of the embodiment, the user input is a poll answer posed as user input by an end user in one of the multiplicity of different surface computing displays in response to a poll posed as user input in another of the multiplicity of the different surface computing systems. In even yet another aspect of the embodiment, the user input is a graphical state of the public space in connection with an end user providing the user input through one of the multiplicity of the different surface computing displays. Finally, the graphical state can be an indication that a chair is vacant proximate to the end user providing the user input through one of the multiplicity of the different surface computing displays.

In another embodiment of the invention, a method for surface computing based social interaction is provided. The method includes projecting by a surface computing system disposed in a public space, a multiplicity of different surface computing displays upon respectively different flat surfaces in the public space, each of the different surface computing displays including a single application user interface to a collaborative application executing in the surface computing system. The method also includes concurrently accepting user input through the single application user interface of different ones of the different surface computing displays. The method further includes providing accepted user input from each of the different surface computing displays to the collaborative computing application. Finally, the method includes presenting through all of the different surface computing displays the accepted user input to the collaborative computing application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for surface computing based social interaction;

FIG. 2 is a schematic illustration of a surface computing data processing system configured for surface computing based social interaction; and,

FIG. 3 is a flow chart illustrating a process for surface computing based social interaction.

### DETAILED DESCRIPTION OF THE INVENTION

Embodiments of the invention provide for surface computing based social interaction. In accordance with an embodiment of the invention, a surface computing display can be projected onto different flat surfaces of a public space. Each projected display can accept input from an end user. For example, the input can be a question posed by the end user, or a textual or graphical state indicator of the state of mind of the end user. The input of the end user then can be displayed in the others of the projected displays. In this way, other end users viewing the input can act upon the information present in the input in the context of the public space. Optionally, one or more of the other end users can post responsive input through respective ones of the projected displays for presentation to the others of the end users.

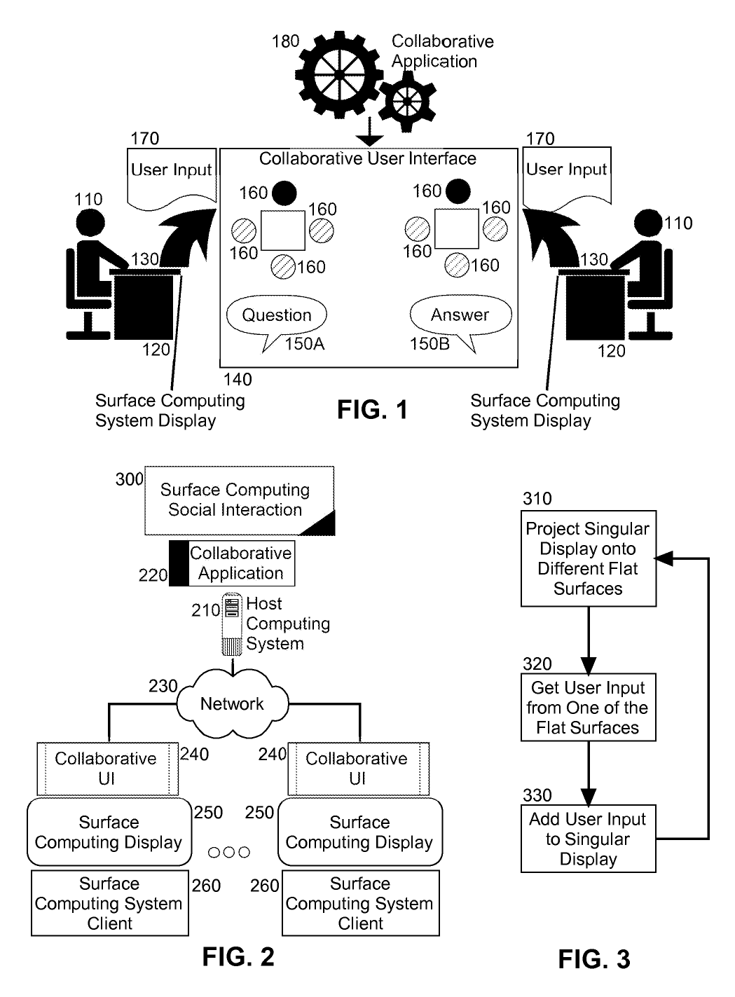

In further illustration, FIG. 1 is a pictorial illustration of a process for surface computing based social interaction. As shown in FIG. 1, a collaborative user interface 140 for a collaborative application 180 can be provided in surface computing data processing system providing multiple different surface computing displays 130 on respective flat surfaces 120 for viewing by different end users 110 in a public space. The collaborative user interface 140 can include a visual display of different user input 170 received from the end users 110 through the multiple different surface computing displays 130.

In this regard, the user input 170 can be a question 150A posed by one of the end users 110. Also, the user input 170 can be an answer 150B to the question 150A provided by another of the end users 110. In one aspect of the embodiment, the question 150A can be a poll posed by one of the end users 110 and the answer 150B can be a response to the poll. In another aspect of the embodiment, the user input 170 can be a graphical indication 160 of a state of the public space associated with a corresponding one of the end users 110. For instance, the graphical state may be an indication that a chair is vacant proximate to the end user 110 providing the user input 170 through one of the multiplicity of the different surface computing displays 130.

The process described in connection with FIG. 1 can be implemented in a surface computing data processing system. In yet further illustration, FIG. 2 schematically shows a surface computing data processing system configured for surface computing based social interaction. The system can include a host computing system 210 that includes one or more computers each with memory and at least one processor. The host computing system 210 can support the operation of a collaborative application 220 in which multiple different end users exchange data in a single workspace from over a computer communications network 230 through respectively different collaborative application user interfaces 240, each of the collaborative application user interfaces 240 providing a singular view to the single workspace.

Of note, a multiplicity of surface computing clients 260 can be communicatively coupled to the host computing system 210 over the computer communications network 230. Further, each of the surface computing clients 260 can include a corresponding surface computing display 250 enabled to project upon a flat surface the collaborative application user interface 240 so as to provide on each flat surface a singular view to the single workspace. Finally, a surface computing social interaction module 300 can be coupled to the collaborative application 220.

The surface computing social interaction module 300 can include program code that when executed in the memory of the host computing system 210, can be enabled to accept user input through each of the surface computing displays 250 and to display the accepted user input in the collaborative application user interface 240 for each of the surface computing system clients 260. Also, the program code of the surface computing social interaction module 300 can be enabled to accept additional user input through each of the surface computing displays 250 in response to the previously accepted user input. Thereafter, the additional user input also can be displayed in the collaborative application user interface 240 for each of the surface computing system clients 260.

In even yet further illustration of the operation of the surface computing social interaction module 300, FIG. 3 is a flow chart illustrating a process for surface computing based social interaction. Beginning in block 310, a singular display can be projected onto different flat surfaces in a public space. In block 320, user input can be received from one of the displays on the flat surfaces. Finally, in block 330 the received user input can be added to the singular display and in block 310 the singular display with the added user input can be projected onto the different flat surfaces of the public space.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A surface computing data processing system configured for surface computing based social interaction, the system comprising:
a surface computing system disposed in a public space comprising a host computing system of at least one computer with memory and at least one processor and an operating system executing thereon and hosting operation of a collaborative computing application generating a single application user interface; and,
a multiplicity of different surface computing displays each projected upon a different flat surface in the public space, each of the different surface computing displays projecting the single application user interface, each of the different surface computing displays concurrently accepting user input through the single application user interface, and each of the different surface computing displays providing accepted user input to the collaborative computing application;
the collaborative computing application comprising program code executing in the memory of the surface computing system and enabled to present through all surface computing displays the accepted user input to the collaborative computing application.

2. The system of claim 1, wherein the user input is a question pertaining to the public space.

3. The system of claim 1, wherein the user input is a response provided as user input in one of the multiplicity of different surface computing displays to a question provided as user input in another of the multiplicity of the different surface computing displays.

4. The system of claim 1, wherein the user input is a poll answer posed as user input by an end user in one of the multiplicity of different surface computing displays in response to a poll posed as user input in another of the multiplicity of the different surface computing systems.

5. The system of claim 1, wherein the user input is a graphical state of the public space in connection with an end user providing the user input through one of the multiplicity of the different surface computing displays.

6. The system of claim 5, wherein the graphical state is an indication that a chair is vacant proximate to the end user providing the user input through one of the multiplicity of the different surface computing displays.

7-12. (canceled)

13. A computer program product for surface computing based social interaction, the computer program product comprising a computer readable storage medium having program instructions embodied therewith, the program instructions executable by a device to cause the device to perform a method comprising:
projecting by the device a multiplicity of different surface computing displays upon respectively different flat surfaces in a public space, each of the different surface computing displays including a single application user interface to a collaborative application executing in a surface computing system;
concurrently accepting by the device user input through the single application user interface of different ones of the different surface computing displays;
providing by the device accepted user input from each of the different surface computing displays to the collaborative computing application; and,
presenting by the device through all of the different surface computing displays the accepted user input to the collaborative computing application.

14. The computer program product of claim 13, wherein the user input is a question pertaining to the public space.

15. The computer program product of claim 13, wherein the user input is a response provided as user input in one of the multiplicity of different surface computing displays to a question provided as user input in another of the multiplicity of the different surface computing displays.

16. The computer program product of claim 13, wherein the user input is a poll answer posed as user input by an end user in one of the multiplicity of different surface computing displays in response to a poll posed as user input in another of the multiplicity of the different surface computing systems.

17. The computer program product of claim 13, wherein the user input is a graphical state of the public space in connection with an end user providing the user input through one of the multiplicity of the different surface computing displays.

18. The computer program product of claim 17, wherein the graphical state is an indication that a chair is vacant proximate to the end user providing the user input through one of the multiplicity of the different surface computing displays.
